(19) United States
(12) Patent Application Publication
(10) Pub. No.: US 2013/0029185 A1
(43) Pub. Date: Jan. 31, 2013

(54) Electrochemical System Having a System for Determining a State of Charge

(71) Applicants: David Ridley, Newark, CA (US); Jonathan L. Hall, San Mateo, CA (US); Gerardo Jose Ia O', Alameda, CA (US); Rick Winter, Orinda, CA (US); Thomas Stepien, Portola Valley, CA (US)

(72) Inventors: David Ridley, Newark, CA (US); Jonathan L. Hall, San Mateo, CA (US); Gerardo Jose Ia O', Alameda, CA (US); Rick Winter, Orinda, CA (US); Thomas Stepien, Portola Valley, CA (US)

(73) Assignee: Primus Power Corporation, Hayward, CA (US)

(21) Appl. No.: 13/192,243

(22) Filed: Jul. 27, 2011

(51) Int. Cl. H01M 10/48; H01M 2/38

(52) U.S. Cl. 429/51; 429/91; 429/50

(57) ABSTRACT

An electrochemical system, such as a flow battery, includes a vessel. The vessel contains at least one cell that includes a first electrode, a second electrode and a reaction zone between the first and second electrodes. The vessel also contains a flow circuit configured to deliver a fluid comprising a liquefied halogen reactant and at least one metal halide electrolyte to the at least one cell, and at least one sensor configured to measure a property of the electrochemical system indicative of a state of charge (SOC) of the electrochemical system.

### FIELD

The present invention is directed to electrochemical systems and methods of using same.

### BACKGROUND

The development of renewable energy sources have revitalized the need for large-scale batteries for off-peak energy storage. The requirements for such an application differ from those of other types of rechargeable batteries such as lead-acid batteries.

Batteries for off-peak energy storage in the power grid generally are required to be of low capital cost, long cycle life, high efficiency, and low maintenance.

One type of electrochemical energy system suitable for such an energy storage is a so-called “flow battery” which uses a halogen component for reduction at a normally positive electrode, and an oxidizable metal adapted to become oxidized at a normally negative electrode during the normal operation of the electrochemical system. An aqueous metal halide electrolyte is used to replenish the supply of halogen component as it becomes reduced at the positive electrode. The electrolyte is circulated between the electrode area and a reservoir area. One example of such a system uses zinc as the metal and chlorine as the halogen.

Such electrochemical energy systems are described in, for example, U.S. Pat. Nos. 3,713,888, 3,993,502, 4,001,036, 4,072,540, 4,146,680, and 4,414,292, and in EPRI Report EM-1051 (Parts 1-3) dated April 1979, published by the Electric Power Research Institute, the disclosures of which are hereby incorporated by reference in their entirety.

### SUMMARY

In one embodiment, an electrochemical system comprises a vessel. The vessel contains at least one cell that comprises a first electrode, a second electrode and a reaction zone between the first and second electrodes. The vessel also contains a flow circuit configured to deliver a fluid comprising a liquefied halogen reactant and at least one metal halide electrolyte to the at least one cell, and at least one sensor configured to measure a property of the electrochemical system indicative of a state of charge (SOC) of the electrochemical system.

In another embodiment a method of determining a state of charge (SOC) of an electrochemical system is provided. The electrochemical system comprises a vessel which contains at least one cell that comprises a first electrode, a second electrode, and a reaction zone between the first and second electrodes.

The method comprises measuring a property of the electrochemical system as a flow of a fluid comprising a metal halide electrolyte and a halogen reactant are conveyed through the reaction zone of the at least one cell, and determining the SOC of the electrochemical system based on the measured property.

### BRIEF DESCRIPTION OF THE DRAWINGS

FIG. 1 illustrates a side cross section view of an embodiment of the electrochemical system with a sealed container containing a stack of electrochemical cells.

FIG. 2 illustrates a side cross section view of flow paths in a stack of horizontally positioned cells.

FIG. 3 illustrates a three dimensional view of cell frames that can be used in certain embodiments of the electrochemical system.

FIG. 4 is a prior art phase diagram for a molecular chlorine as presented in U.S. Pat. No. 3,940,283.

FIG. 5 schematically illustrates a three dimensional view of flow paths in the electrochemical system in a discharge mode.

FIG. 6 schematically illustrates a side cross-sectional view of a reservoir which has a plurality of sensors disposed therein for measuring properties of the system indicative of a state of charge.

FIG. 7 schematically illustrates a side cross-sectional view of a reservoir which has a separation device in a discharge operation of the electrochemical system and sensors for measuring concentration differences in the two volumes separated by the separation device.

FIG. 8 schematically illustrates a side cross-sectional view of a reservoir which has a separation device in a charge operation of the electrochemical system and sensors for measuring concentration differences in the two volumes separated by the separation device.

### DETAILED DESCRIPTION

The following documents, the disclosures of which are incorporated herein by reference in their entirety, can be useful for understanding and practicing the embodiments described herein: U.S. patent application Ser. No. 12/523,146, which is a U.S. National Phase entry of PCT application no. PCT/US2008/051111 filed Jan. 11, 2008, which claims benefit of priority to U.S. patent application Ser. No. 11/654,380 filed Jan. 16, 2007.

The embodiments disclosed herein relate to an electrochemical system (also sometimes referred to as a “flow battery”). The electrochemical system can utilize a metal-halide electrolyte and a halogen reactant, such as molecular chlorine. The halide in the metal-halide electrolyte and the halogen reactant can be of the same type. For example, when the halogen reactant is molecular chlorine, the metal halide electrolyte can contain at least one metal chloride.

The electrochemical system can include a sealed vessel containing an electrochemical cell in its inner volume, a metal-halide electrolyte and a halogen reactant, and a flow circuit configured to deliver the metal-halide electrolyte and the halogen reactant to the electrochemical cell. The sealed vessel can be a pressure vessel that contains the electrochemical cell. The halogen reactant can be, for example, a molecular chlorine reactant.

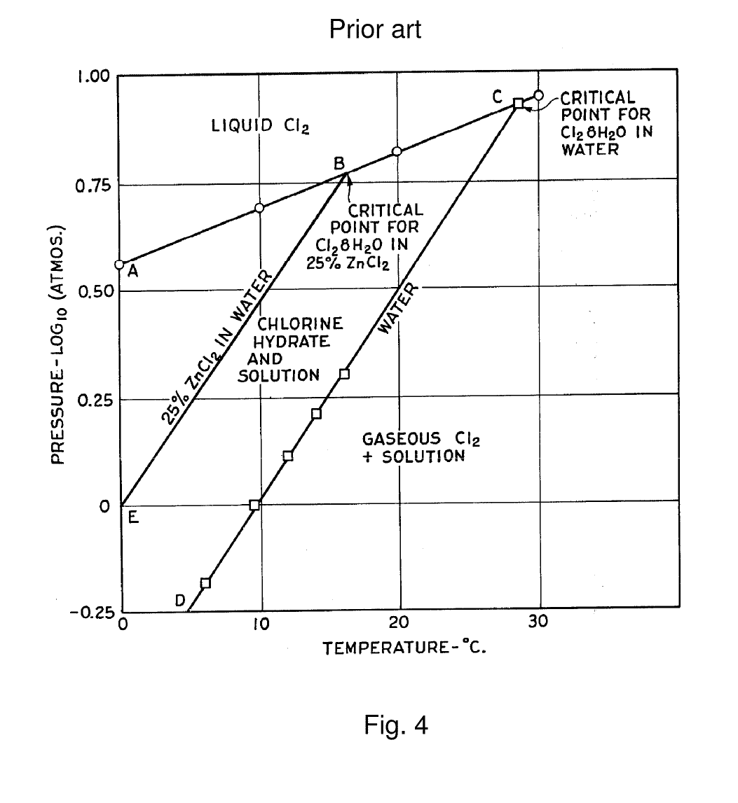

In many embodiments, the halogen reactant may be used in a liquefied form. The sealed vessel is such that it can maintain an inside pressure above a liquefication pressure for the halogen reactant at a given ambient temperature. A liquefication pressure for a particular halogen reactant for a given temperature may be determined from a phase diagram for the halogen reactant. For example, FIG. 4 presents a phase diagram for elemental chlorine, from which a liquefication pressure for a given temperature may be determined. The system that utilizes the liquefied halogen reactant in the sealed container does not require a compressor, while compressors are often used in other electrochemical systems for compression of gaseous halogen reactants. The system that utilizes the liquefied halogen reactant does not require a separate storage for the halogen reactant, which can be located outside the inner volume of the sealed vessel. The term “liquefied halogen reactant” refers to at least one of molecular halogen dissolved in water, which is also known as wet halogen or aqueous halogen, and “dry” liquid molecular halogen, which is not dissolved in water. Similarly, the term “liquefied chlorine” may refer to at least one of molecular chlorine dissolved in water, which is also known as wet chlorine or aqueous chlorine, and “dry” liquid chlorine, which is not dissolved in water.

In many embodiments, the system utilizes a liquefied molecular chlorine as a halogen reactant. The liquefied molecular chlorine has a gravity which is approximately two times greater than that of water.

The flow circuit contained in the sealed container may be a closed loop circuit that is configured to deliver the halogen reactant, preferably in the liquefied or liquid state, and the at least one electrolyte to and from the cell(s). In many embodiments, the loop circuit may be a sealed loop circuit. Although the components, such as the halogen reactant and the metal halide electrolyte, circulated through the closed loop are preferably in a liquefied state, the closed loop may contain therein some amount of gas, such as chlorine gas.

Preferably, the loop circuit is such that the metal halide electrolyte and the halogen reactant circulate through the same flow path without a separation in the cell(s).

Each of the electrochemical cell(s) may comprise a first electrode, which may serve as a positive electrode in a normal discharge mode, and a second electrode, which may serve as a negative electrode in a normal discharge mode, and a reaction zone between the electrodes.

In many embodiments, the reaction zone may be such that no separation of the halogen reactant, such as the halogen reactant or ionized halogen reactant dissolved in water of the electrolyte solution, occurs in the reaction zone. For example, when the halogen reactant is a liquefied chlorine reactant, the reaction zone can be such that no separation of the chlorine reactant, such as the chlorine reactant or chlorine ions dissolved in water of the electrolyte solution, occurs in the reaction zone. The reaction zone may be such that it does not contain a membrane or a separator between the positive and negative electrodes of the same cell that is impermeable to the halogen reactant, such as the halogen reactant or ionized halogen reactant dissolved in water of the electrolyte solution. For example, the reaction zone may be such that it does not contain a membrane or a separator between the positive and negative electrodes of the same cell that is impermeable to the liquefied chlorine reactant, such as the chlorine reactant or chlorine ions dissolved in water of the electrolyte solution.

In many embodiments, the reaction zone may be such that no separation of halogen ions, such as halogen ions formed by reducing the halogen reactant at one of the electrodes, from the rest of the flow occurs in the reaction zone. In other words, the reaction zone may be such that it does not contain a membrane or a separator between the positive and negative electrodes of the same cell that is impermeable for the halogen ions, such as chlorine ions. Furthermore, the cell is preferably is hybrid flow battery cell rather than a redox flow battery cell. Thus, in the hybrid flow battery cell, a metal, such as zinc is plated onto one of the electrodes, the reaction zone lacks an ion exchange membrane which allows ions to pass through it (i.e., there is no ion exchange membrane between the cathode and anode electrodes) and the electrolyte is not separated into a catholyte and anolyte by the ion exchange membrane.

In certain embodiments, the first electrode may be a porous electrode or contain at least one porous element. For example, the first electrode may comprise a porous carbonaceous material such as a porous carbon foam. In a discharge mode, the first electrode may serve as a positive electrode, at which the halogen may be reduced into halogen ions. The use of the porous material in the first electrode may increase efficiency of the halogen reactant's reduction.

In many embodiments, the second electrode may comprise an oxidizable metal, i.e., a metal that may be oxidized to form cations during the discharge mode. In many embodiments, the second electrode may comprise a metal that is of the same type as a metal ion in one of the components of the metal halide electrolyte. For example, when the metal halide electrolyte comprises zinc halide, such as zinc chloride, the second electrode may comprise metallic zinc. In such a case, the electrochemical system may function as a reversible system.

Thus, in some embodiments, the electrochemical system may be reversible, i.e. capable of working in both charge and discharge operation mode; or non-reversible, i.e. capable of working only in a discharge operation mode. The reversible electrochemical system usually utilizes at least one metal halide in the electrolyte, such that the metal of the metal halide is sufficiently strong and stable in its reduced form to be able to form an electrode. The metal halides that can be used in the reversible system include zinc halides, as element zinc is sufficiently stable to be able to form an electrode. On the other hand, the non-reversible electrochemical system does not utilize the metal halides that satisfy the above requirements. Metals of metal halides that are used in the non-reversible systems are usually unstable and strong in their reduced, elemental form to be able to form an electrode. Examples of such unstable metals and their corresponding metal halides include potassium (K) and potassium halides and sodium (Na) and sodium halides.

The metal halide electrolyte can be an aqueous electrolytic solution. The electrolyte may be an aqueous solution of at least one metal halide electrolyte compound, such as ZnCl. For example, the solution may be a 15-50% aqueous solution of ZnCl, such as a 25% solution of ZnCl. In certain embodiments, the electrolyte may contain one or more additives, which can enhance the electrical conductivity of the electrolytic solution. For example, when the electrolyte contains ZnCl, such additive can be one or more salts of sodium or potassium, such as NaCl or KCl.

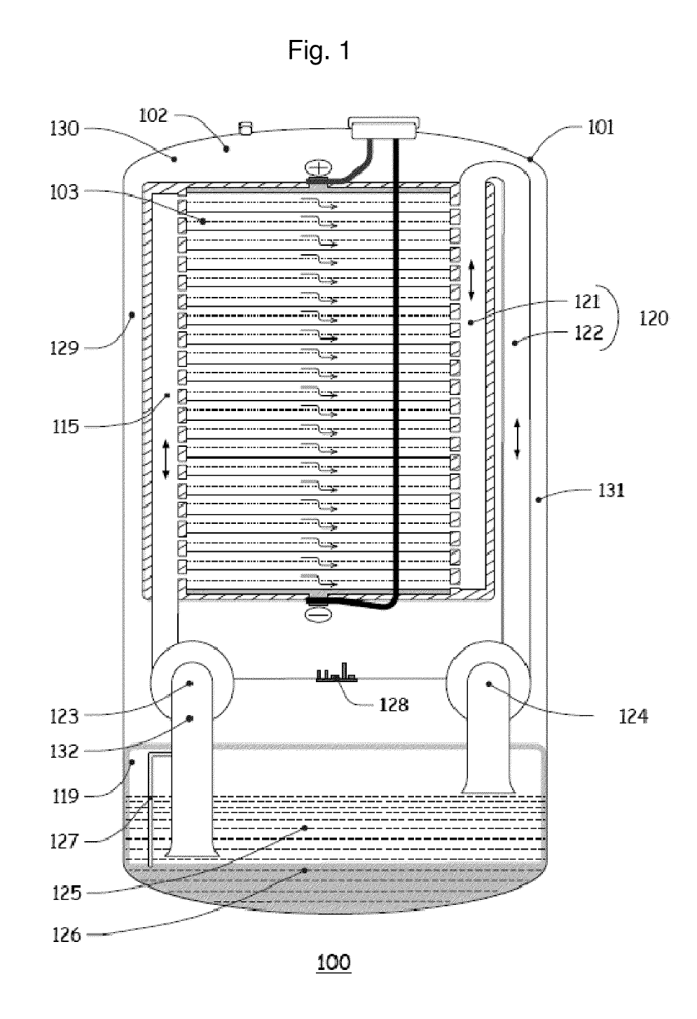

FIG. 1 illustrates an electrochemical system 100 which includes at least one electrochemical cell, an electrolyte and a halogen reactant contained in a sealed container 101. The sealed container 101 is preferably a pressure containment vessel, which is configured to maintain a pressure above one atmospheric pressure in its inner volume 102. Preferably, the sealed container 101 is configured to maintain a pressure in its inner volume above the liquefication pressure for the halogen reactant, such as elemental chlorine. For functioning at a normal temperature such as 10-40° C., the sealed container may be configured to maintain an inside pressure of at least 75 psi or of at least 100 psi or of at least 125 psi or of at least 150 psi or of at least 175 psi or of at least 200 psi or of at least 250 psi or of at least 300 psi or of at least 350 psi or of at least 400 psi or of at least 450 psi or of at least 500 psi or of at least 550 psi or of at least 600 psi, such as 75-650 psi or 75-400 psi and all subranges described previously. The walls of the sealed container may be composed of a structural material capable to withstand the required pressure. One non-limiting example of such a material is stainless steel.

The at least one electrochemical cell contained inside the sealed container 101 is preferably a horizontally positioned cell, which may include a horizontal positive electrode and horizontal negative electrode separated by a gap. The horizontally positioned cell may be advantageous because when the circulation of the liquid stops due to, for example, turning off a discharge or a charge pump, some amount of liquid (the electrolyte and/or the halogen reactant) may remain in the reaction zone of the cell. The amount of the liquid may be such that it provides electrical contact between the positive and negative electrodes of the same cell. The presence of the liquid in the reaction zone may allow a faster restart of the electrochemical system when the circulation of the metal halide electrolyte and the halogen reagent is restored compared to systems that utilize a vertically positioned cell(s), while providing for shunt interruption. The presence of the electrolyte in the reaction zone may allow for the cell to hold a charge in the absence of the circulation and thus, ensure that the system provides uninterrupted power supply (UPS). The horizontally positioned cell(s) in a combination with a liquefied chlorine reactant used as a halogen reactant may also prevent or reduce a formation of chlorine bubbles during the operation.

In many embodiments, the sealed container may contain more than one electrochemical cell. In certain embodiments, the sealed container may contain a plurality of electrochemical cells, which may be connected in series. In some embodiments, the plurality of electrochemical cells that are connected in series may be arranged in a stack. For example, element 103 in FIG. 1 represents a vertical stack of horizontally positioned electrochemical cells, which are connected in series. The stack of horizontally positioned cells may be similar to the one disclosed on pages 7-11 and FIGS. 1-3 of WO2008/089205, which is incorporated herein by reference in its entirety. The advantages of a single horizontally positioned cell apply to the stack as well.

The electrochemical system can include a feed pipe or manifold that may be configured in a normal discharge operation mode to deliver a mixture comprising the metal-halide electrolyte and the liquefied halogen reactant to the at least one cell. The electrochemical system may also include a return pipe or manifold that may be configured in the discharge mode to collect products of an electrochemical reaction from the at least one electrochemical cell. Such products may be a mixture comprising the metal-halide electrolyte and/or the liquefied halogen reactant, although the concentration of the halogen reactant in the mixture may be reduced compared to the mixture entering the cell due to the consumption of the halogen reactant in the discharge mode.

For example, in FIG. 1 a feed pipe or manifold 115 is configured to deliver a mixture comprising the metal-halide electrolyte and the liquefied halogen reactant to the horizontally positioned cells of the stack 103. A return pipe or manifold 120 is configured to collect products of an electrochemical reaction from cells of the stack. As will be further discussed, in some embodiments, the feed pipe or manifold and/or the return pipe or manifold may be a part of a stack assembly for the stack of the horizontally positioned cells. In some embodiments, the stack 103 may be supported directly by walls of the vessel 101. Yet in some embodiments, the stack 103 may be supported by one or more pipes, pillars or strings connected to walls of the vessel 101 and/or reservoir 119.

The feed pipe or manifold and the return pipe or manifold may be connected to a reservoir 119 that may contain the liquefied, e.g. liquid, halogen reactant and/or the metal halide reactant. Such a reservoir may be located within the sealed container 101. The reservoir, the feed pipe or manifold, the return pipe or manifold and the at least one cell may form a loop circuit for circulating the metal-halide electrolyte and the liquefied halogen reactant.

The metal-halide electrolyte and the liquefied halogen reactant may flow through the loop circuit in opposite directions in charge and discharge modes. In the discharge mode, the feed pipe or manifold 115 may be used for delivering the metal-halide electrolyte and the liquefied halogen reactant to the at least one cell 103 from the reservoir 119 and the return pipe or manifold 120 for delivering the metal-halide electrolyte and the liquefied halogen reactant from the at least one cell back to the reservoir. In the charge mode, the return pipe or manifold 120 may be used for delivering the metal-halide electrolyte and/or the liquefied halogen reactant to the at least one cell 103 from the reservoir 119 and the feed pipe or manifold 115 for delivering the metal-halide electrolyte and/or the liquefied halogen reactant from the at least one cell 103 back to the reservoir 119.

In some embodiments, when the system utilizes a vertical stack of horizontally positioned cells, the return pipe or manifold 120 may be an upward-flowing return pipe or manifold. The pipe 120 includes an upward running section 121 and a downward running section 122. The flow of the metal-halide electrolyte and the liquefied halogen electrolyte leaves the cells of the stack 103 in the discharge mode upward through the section 121 and then goes downward to the reservoir through the section 122. The upward flowing return pipe or manifold may prevent the flow from going mostly through the bottom cell of the stack 103, thereby, providing a more uniform flow path resistance between the cells of the stack.

The electrochemical system may include one or more pumps for pumping the metal-halide electrolyte and the liquefied halogen reactant. Such a pump may or may not be located within the inner volume of the sealed vessel. For example, FIG. 1 shows discharge pump 123, which fluidly connects the reservoir 119 and the feed pipe or manifold 115 and which is configured to deliver the metal-halide electrolyte and the liquefied halogen reactant through the feed pipe or manifold 115 to the electrochemical cell(s) 103 in the discharge mode. In some embodiments, the electrochemical generation system may include charge pump depicted as element 124 in FIG. 1. The charge pump fluidly connects the return pipe or manifold 120 to the reservoir 119 and can be used to deliver the metal-halide electrolyte and the liquefied halogen reactant through the return pipe or manifold to the electrochemical cell(s) in the charge mode. In some embodiments, the electrochemical system may include both charge and discharge pumps. The charge and discharge pumps may be configured to pump the metal-halide electrolyte and the liquefied halogen reactant in the opposite directions through the loop circuit that includes the feed pipe or manifold and the return pump or manifold. Preferably, the charge and discharge pumps are configured in such a way so that only one pump operates at a given time. Such an arrangement may improve the reliability of the system and increase the lifetime of the system. The opposite pump arrangement may also allow one not to use in the system a valve for switching between the charge and discharge modes. Such a switch valve may often cost more than an additional pump. Thus, the opposite pump arrangement may reduce the overall cost of the system.

Pumps that are used in the system may be centripetal pumps. In some embodiments, it may be preferred to use a pump that is capable to provide a pumping rate of at least 30 L/min.

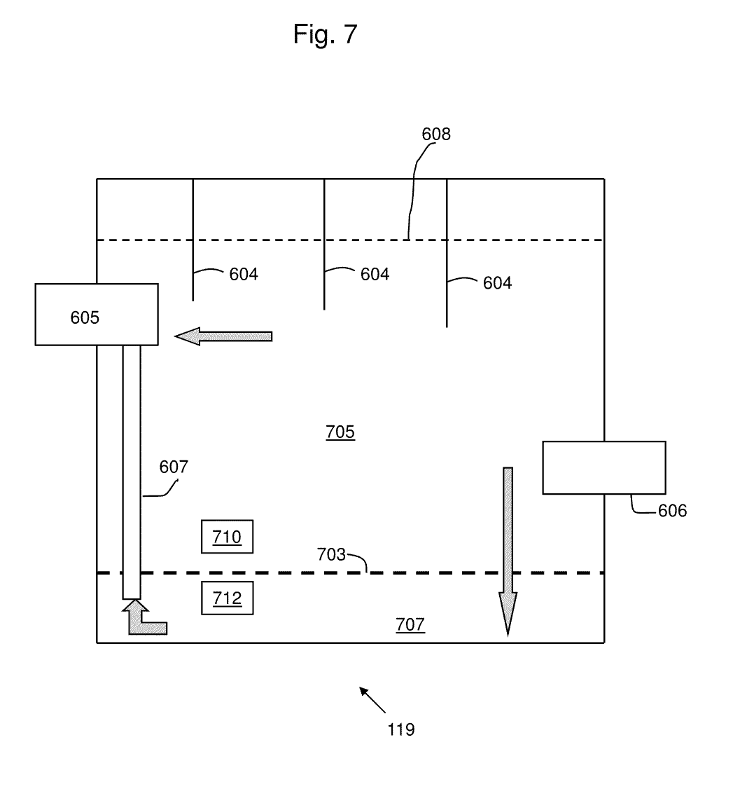

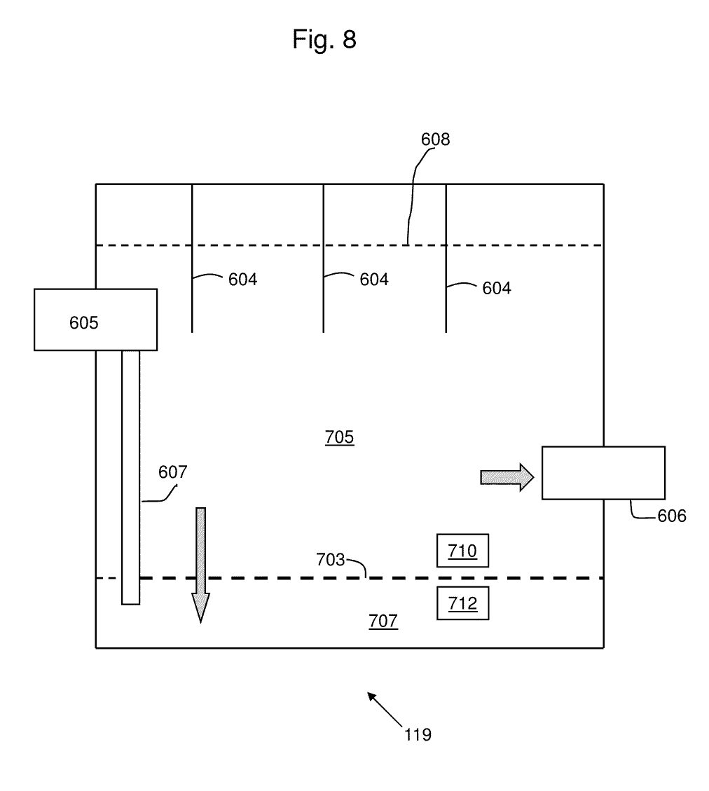

FIG. 1 depicts the reservoir as element 119. The reservoir 119 may be made of a material that is inert to the halogen reactant. One non-limiting example of such an inert material may be a polymer material, such as polyvinyl chloride (PVC). The reservoir 119 may also store the metal halide electrolyte. In such a case, if the liquefied chlorine is used as a liquefied halogen reactant, then the chlorine can be separated from the metal halide electrolyte due to a higher density (specific gravity) of the former, and/or by a separation device as described below with respect to FIGS. 7 and 8. FIG. 1 shows liquefied chlorine at the lower part of the reservoir (element 126) and the metal-halide electrolyte being above the liquefied chlorine in the reservoir (element 125).

The reservoir 119 may contain a feed line for the liquefied halogen reactant, which may supply the halogen reactant 126 to the feed pipe or manifold 115 of the system. A connection between the halogen reactant feed line and the feed manifold of the system may occur before, at or after a discharge pump 123. In some embodiments, the connection between the halogen reactant feed line and the feed manifold of the system may comprise a mixing venturi. FIG. 1 presents the feed line for the liquefied halogen reactant as element 127. An inlet of the feed line 127, such as a pipe or conduit, may extend to the lower part 126 of the reservoir 119, where the liquefied halogen reactant, such as the liquefied chlorine reactant, may be stored. An outlet of the feed line 127 is connected to an inlet of the discharge pump 123. The electrolyte intake feed line, such as a pipe or conduit 132, may extend to the upper part 125, where the metal-halide electrolyte is located.

In some embodiments, the reservoir 119 may include one or more sump plates, which may be, for example, a horizontal plate with holes in it. The sump plate may facilitate the settling down of the liquefied halogen reactant, such as liquefied chlorine reactant, at the lower part 126 of the reservoir, when the liquefied halogen reactant returns to the reservoir 119, for example, from the return pipe or manifold 120 in the discharge mode. The reservoir 119 is preferably but not necessarily located below the stack of cells 103.

In some embodiments, the reservoir 119 may include one or more baffle plates. Such baffle plates may be vertical plates located at the top and bottom of the reservoir. The baffle plates may reduce and/or prevent eddy currents in the returning flow of the metal-halide electrolyte and the liquefied halogen reactant, thereby enhancing the separation of the liquefied halogen from the metal-halide electrolyte in the reservoir.

In certain embodiments, the discharge pump may be positioned with respect to the reservoir so that it's inlet/outlet is located below the upper level of the metal-halide electrolyte in the reservoir. In certain embodiments, the inlet/outlet of the discharge pump may be positioned horizontally or essentially horizontally. In such an arrangement, the flow of the metal-halide electrolyte and the liquefied halogen reactant may make a 90 degree turn in the discharge pump from a horizontal direction in the inlet to a vertical direction in the feed manifold or pipe 115. In some embodiments, the inlet of the discharge pump 123 may include a bellmouth piece, which may slow down the flow and thereby prevent/reduce formation of turbulence in the reservoir.

The charge pump may also be positioned with it's inlet/outlet located below the upper level of the metal-halide electrolyte in the reservoir. In certain embodiments, the inlet/outlet of the charge pump may be located at a lower level than the inlet/outlet of the discharge pump. The inlet/outlet of the charge pump may also have a bellmouth piece, which may slow down the flow and thereby prevent/reduce formation of turbulence in the reservoir.

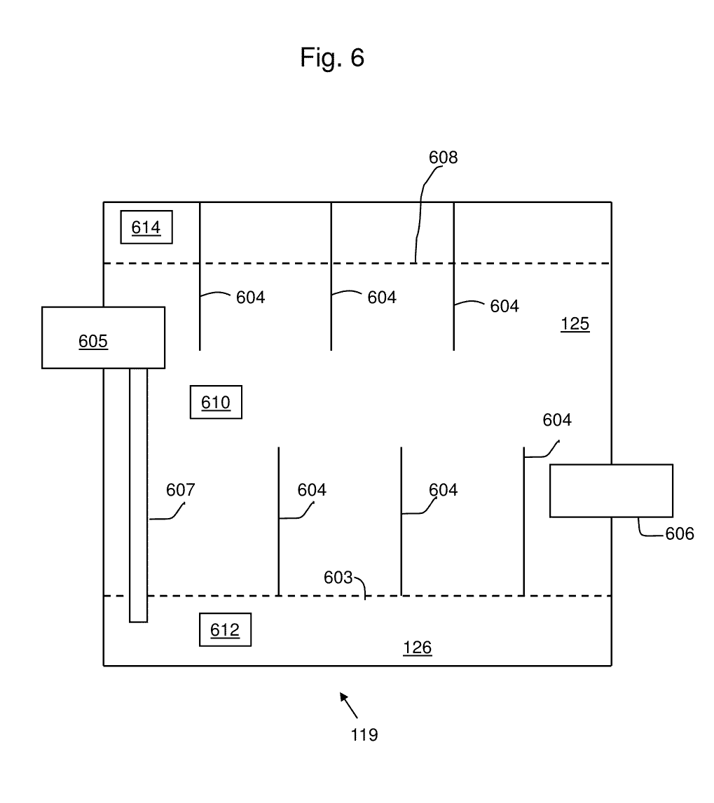

FIG. 6 illustrates the reservoir 119 which has a lower part 126, which may contain the liquefied halogen reactant, such as a liquefied molecular chlorine reactant; an upper part 125, which may contain the metal halide reactant; a horizontal sump plate 603, vertical baffle plates 604, a horizontal inlet 605 of a discharge pump, a horizontal outlet 606 of a charge pump and a feed line 607 for the liquefied halogen reactant, which has an inlet in the lower part 126 of the reservoir and which is connected to the discharge pump's inlet 605. The sump plate 603 is positioned approximately at the level where the boundary between the metal-halide electrolyte and the halogen reactant is expected to be located. Line 608 schematically depicts the upper level of the metal-halide electrolyte in the reservoir. Discharge pump's inlet 605 and charge pump's outlet 606 may protrude through the walls of the reservoir.

In some embodiments, the electrochemical system may include a controlling element, which may be used, for example, for controlling a rate of the discharge pump, a rate of the charge pump and/or a rate of feeding the halogen reactant into the electrolyte. Such a controlling element may be an analog circuit. FIG. 1 depicts the controlling element as element 128, which may control one or more of the following parameters: rates of the charge pump 124 and the discharge pump 123 and a feed rate of the liquefied chlorine reactant through the feed line 127.

The inner volume of the sealed container may have several pressurized zones, each having a different pressure. For example, the inner volume may include a first zone, and a second zone having a pressure higher than that of the first zone. In some embodiments, the first zone may be enveloped or surrounded by the second, higher pressure zone. The first zone may contain the electrolyte/liquefied halogen reactant loop, i.e. the reservoir 119, the cell(s) 103, pump(s) 123 and 124, manifold(s) 115, 120, while the second surrounding or enveloping zone may be a space between the first zone and the walls of the sealed vessel 101. In FIG. 1, the cells 103, the feed manifold or pipe 115, the reservoir 119, including the metal halide reactant in the upper part 125 of the reservoir and the liquefied halogen reactant in its lower part 126, and the return manifold or pipe 120 all may be in the first pressure zone, while the higher pressure second zone may be represented by the areas 129, 130 and 131 of the inner volume of the vessel 101.

In such an arrangement, a pressure in the first zone may be a pressure sufficient to liquefy the halogen reactant at a given temperature. Such a pressure may be at least 75 psi or at least 100 psi or at least 125 psi or at least 150 psi or at least 175 psi or at least 200 psi or at least 250 psi or at least 300 psi or at least 350 psi or at least 400 psi, such as 75-450 psi or 75-400 psi and all subranges in between. At the same time, a surrounding pressure in the second pressure zone may be higher than a maximum operating pressure of the first zone. Such a surrounding pressure may be at least 75 psi or at least 100 psi or at least 125 psi or at least 150 psi or at least 175 psi or at least 200 psi or at least 250 psi or at least 300 psi or at least 350 psi or at least 400 psi or at least 450 psi or at least 500 psi or at least 550 psi or at least 600 psi, such as 75-650 psi or 200-650 psi or 400-650 psi and all the subranges in between.

The enveloped arrangement may provide a number of advantages. For example, in the event of a leak from the first zone/loop circuit, the higher pressure in the surrounding second zone may cause the leaking component(s) to flow inwards the first zone, instead of outwards. Also, the surrounding higher pressure zone may reduce/prevent fatigue crack propagation over components of the first zone/loop circuit, including components made of plastic, such as manifolds and walls of reservoir. The pressurized envelope arrangement may also allow using thinner outer wall(s) for the sealed container/vessel, which can, nevertheless, prevent deformation(s) that could negatively impact internal flow geometries for the metal-halide electrolyte and the liquefied halogen reactant. In the absence of the pressurizing second zone, thicker outer wall(s) may be required to prevent such deformation(s) due to an unsupported structure against expansive force of the internal higher pressure.

In certain embodiments, the outer walls of the sealed container/vessel may be formed by a cylindrical component and two circular end plates, one of which may be placed on the top of the cylindrical component and the other on the bottom in order to seal the vessel. The use of the pressurized envelope arrangement for such outer walls allows using thinner end plates, without exposing internal flow geometries for the metal-halide electrolyte and the liquefied halogen reactant compared to the case when the outer walls are exposed to the variable pressure generated during the operation of the system.

The second pressure zone may be filled with an inert gas, such as argon or nitrogen. In some embodiments, the second pressure zone may also contain an additional component that can neutralize a reagent, such as the halogen reactant, that is leaking from the first zone, and/or to heal walls of the first zone/loop circuit. Such an additional material may be, for example, a soda ash. Thus, spaces 129, 130 and 131 may be filled with soda ash.

The electrochemical system in a pressurized envelope arrangement may be fabricated as follows. First, a sealed loop circuit for the metal halide electrolyte and the liquefied halogen reagent may be fabricated. The sealed loop circuit can be such that it is capable to maintain an inner pressure above a liquefication pressure of the liquefied halogen for a given temperature. The sealed loop circuit may include one or more of the following elements: one or more electrochemical cells, a reservoir for storing the metal-halide electrolyte and the liquefied halogen reactant; a feed manifold or pipe for delivering the metal-halide electrolyte and the liquefied halogen reactant from the reservoir to the one or more cells; a return manifold for delivering the metal-halide electrolyte and the liquefied halogen reactant from the one or more cells back to the reservoir; and one or more pumps. After the loop circuit is fabricated, it may be placed inside a vessel or container, which may be later pressurized to a pressure, which is higher than a maximum operation pressure for a loop circuit, and sealed. The pressurization of the vessel may be performed by pumping in an inert gas, such as argon or nitrogen, and optionally, one or more additional components. When the walls of the vessel are formed by a cylindrical component and two end plates, the sealing procedure may include the end plates at the top and the bottom of the cylindrical component.

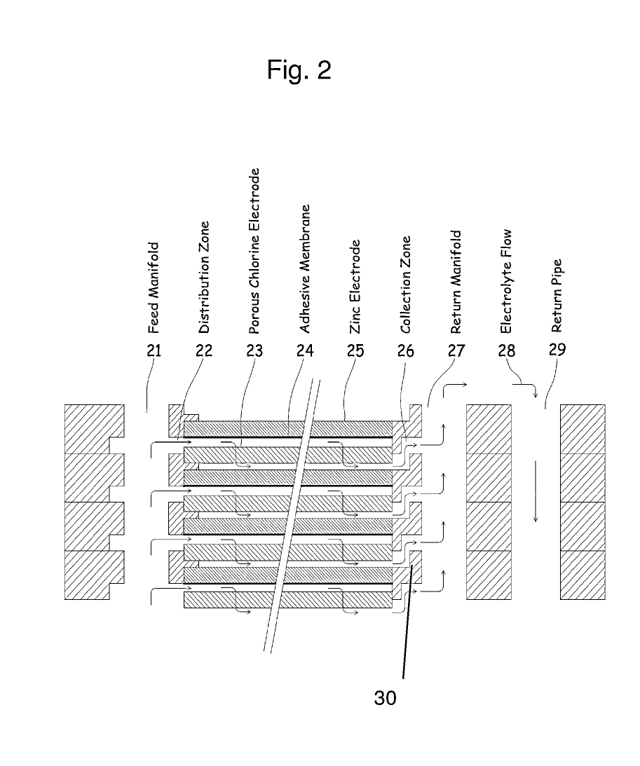

FIG. 2 illustrates paths for a flow of the metal-halide electrolyte and the liquefied halogen reactant through the horizontally positioned cells of the stack, such as the stack 103 of FIG. 1, in the discharge mode. The electrolyte flow paths in FIG. 2 are represented by arrows. For each of the cells in the stack, the flow may proceed from a feed pipe or manifold 21 (element 115 in FIG. 1), into a distribution zone 22, through a porous “chlorine” electrode 23, over a metal electrode 25, which may comprise a substrate, which may be, for example, a titanium substrate or a ruthenized titanium substrate, and an oxidizable metal, which may be, for example, zinc, on the substrate, to a collection zone 26, through an upward return manifold 27 (element 121 in FIG. 1), and to a return pipe 29 (element 122 in FIG. 1).

In some embodiments, an element 24 may be placed on a bottom of metal electrode 25. Yet in some other embodiments, such an element may be omitted. The purpose of the element 24 may be to prevent the flow of the metal-halide electrolyte from contacting the active metal electrode, when passing through a porous electrode of an adjacent cell located beneath. In some cases, the element 24 may comprise the polymer or plastic material.

FIG. 2 also shows barriers 30. Each barrier 30 may be a part of a cell frame discussed in a greater detail below. Barrier 30 may separate the positive electrode from the negative electrode of the same cell. Barriers 30 may comprise an electrically insulating material, which can be a polymeric material, such as poly vinyl chloride (PVC).

In the configuration depicted in FIG. 2, the metal-halide electrolyte may be forced to flow down through the porous electrode and then up to leave the cell. Such a down-and-up flow path may enable an electrical contact of the porous electrode and the metal electrode in each cell with a pool of the metal halide electrolyte remaining in each cell when the electrolyte flow stops and the feed manifold, distribution zone, collection zone, and return manifold drain. Such a contact may allow maintaining an electrical continuity in the stack of cells when the flow stops and may provide for an uninterrupted power supply (UPS) application without continuous pump operation. The down-and-up flow path within each cell may also interrupt shunt currents that otherwise would occur when electrolyte flow stops. The shunt currents are not desired because they may lead to undesirable self-discharge of the energy stored in the system and an adverse non-uniform distribution of one or more active materials, such as an oxidizable metal, such as Zn, throughout the stack.

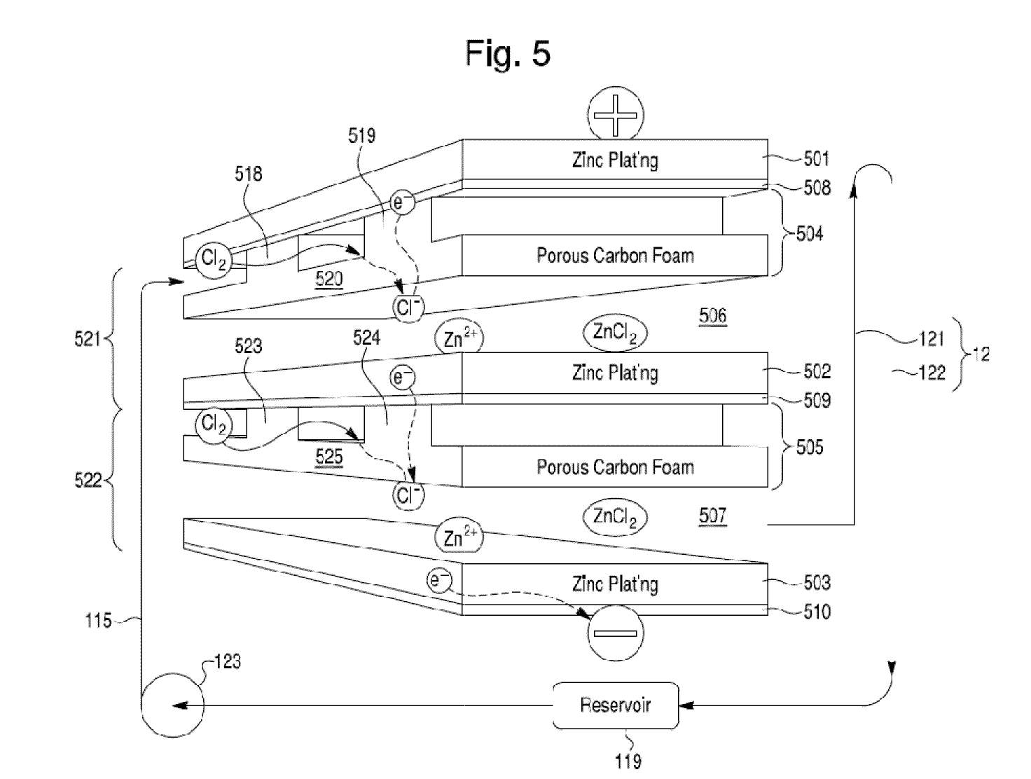

FIG. 5 further illustrates flow paths through the stacked cells using ZnCl₂ as an exemplary metal-halide electrolyte and Cl₂ as an exemplary halogen reactant. The stack in FIG. 5 includes a cell 521, which has a reaction zone 506 between a positive electrode 504, e.g. porous carbon “chlorine” electrode, and a negative electrode 502, e.g. zinc electrode, and a cell 522, which has a reaction zone 507 between a positive electrode 505 and a negative electrode 503. The negative electrode 502 of the cell 522 is electrically connected to the positive electrode 505 of the cell 521, thereby providing electrical continuity between the cells of the stack. Each of the negative electrodes may comprise a conductive impermeable element, which is similar to the element 24 in FIG. 2. Such element is shown as element 509 for the electrode 502 and element 510 for the electrode 503.

FIG. 5 also shows an electrode 501 or a terminal plate positioned over the positive electrode 504 of the cell 521. When the cell 521 is the top terminal cell, the electrode 501 can be the terminal positive electrode of the stack. If the cell 521 is not the terminal cell, then the electrode 521 can be a negative electrode of an adjacent cell of the stack. The positive electrodes 504 and 505 are preferably porous electrodes, such as porous carbonaceous electrodes, such as carbon foam electrode.

The cells may be arranged in the stack in such a manner that a cell-to-cell distance may be significantly greater that a distance between positive and negative electrodes of a particular cell of the stack (an interelectrode distance). The interelectrode distance may be, for example, 0.5-5 mm such as 1-2 mm. In some embodiments, the cell-to-cell distance may be at least 3 times or at least 5 times or at least 8 times or at least 10 times, such as 3-15 times greater, than the interelectrode distance. The cell-to-cell distance may be defined as between two analogous surfaces in two adjacent cells. For example, the cell-to-cell distance may be a distance between an upper surface of the negative electrode 502 of the cell 521 and an upper surface of the negative electrode 503 of the cell 522. The cell-to-cell distance may be 5-20 mm, such as 10-15 mm. The distance between a particular cell's positive and negative electrodes in FIG. 5 is a distance between the lower surface of the positive electrode 504 of the cell 521 and the upper surface of the negative electrode 502 of the same cell.

To achieve the significant difference between the cell to cell distance and the interelectrode distance in a particular cell, at least one of positive or negative electrodes may comprise one or more electrically conductive spacers, which (i) increase the cell-to-cell distance compared to the interelectrode distance and (ii) provide a electrical contact between positive and negative electrodes of adjacent cells.

In FIG. 5, the positive electrode 505 of the cell 522 has a porous part 525 and two conductive spacers 523 and 524, which are electrically connected to the negative electrode 502 of the adjacent cell 521. The conductive spacers 523 and 524 may or may not be made of a porous material. In certain embodiments, conductive spacers, such as spacers 523 and 524, may be made of carbonaceous material, such as graphite. Similarly to the electrode 505, the electrode 504 of the cell 521 contains a porous part 520 and two conductive spacers 518 and 519.

In addition to the cells 521 and 522, FIG. 5 shows a reservoir 119; a feed line 115, which includes a pump 123; and a return manifold 120, which includes an upper running part 121 and a part 122, which is connected with the reservoir 119. Together the reservoir 119, the feed line 115, the return manifold 120 and the reaction zones 506 and 507 form a closed loop (e.g. flow circle) for the metal halide electrolyte, which is illustrated as ZnCl₂ in FIG. 5, and the halogen reactant (Cl₂ in FIG. 5).

In the discharge mode, a mixture of the metal halide electrolyte and the liquefied halogen reactant arrives from the reservoir 119 at the top of a respective positive electrode of a cell, such as electrode 504 for cell 521 and the electrode 505 for the cell 522. The halogen reactant is reduced at the positive electrode. After the mixture penetrates through a porous part of the positive electrode (part 520 for the cell 521 and part 525 for the cell 522), it becomes enriched with halogen anions (C⁻ in the case of molecular chlorine used as the halogen reactant).

The reaction zone of the cell, such as zone 506 for the cell 521 or zone 507 for the cell 522, does not contain a membrane or a separator configured to separate halogen anions, such as Cl⁻, from the metal halide electrolyte. Thus, from the positive electrode, the halogen anion enriched mixture proceeds down to the negative electrode, such as electrode 502 for the cell 521 and electrode 503 for the cell 522. In the discharge mode, a metal of the negative electrode is oxidized forming positive ions that are released into the halogen anion enriched mixture.

For example, if the negative electrode comprises metallic Zn as shown in FIG. 5, the metallic zinc is oxidized into zinc ions, while releasing two electrons. The electrolyte mixture, which is enriched with both halogen anions and metal cations after contacting the negative electrode, leaves the cell through the upper running return manifold and goes back to the reservoir, where the mixture can be resupplied with a new dose of the liquefied halogen reactant. In sum, in the system illustrated in FIG. 5, the following chemical reactions can take place in the discharge mode:

Cl_{2(Aq)}+2e⁻->2Cl⁻ (positive electrode)

Zn₍ₛ₎->Zn²⁺+2e⁻ (negative electrode).

As the result of these reactions, 2.02 V per cell can be produced.

In the discharge mode, the electrochemical system can consume the halogen reactant and the metal constituting the negative electrode and produce an electrochemical potential. In the charge mode, the halogen reactant and the metal of the electrode may be replenished by applying a potential to the terminal electrodes of the stack. In the charge mode, the electrolyte from the reservoir moves in the direction opposite to the one of the discharge mode.

For FIG. 5, such opposite movement means that the electrolyte moves counterclockwise. In the charge mode, the electrolyte enters the cell, such as cell 521 or 522, after passing through the return manifold 520, at the electrode, which acts as a negative electrode in the discharge mode but as a positive electrode in the charge mode. Such electrodes in FIG. 5 are the electrode 502 for the cell 521 and electrode 503 for the cell 522. At this electrode, the metal ions of the electrolyte may be reduced into elemental metal, which may be deposited back at the electrode. For example, for the system in FIG. 5, zinc ions may be reduced and deposited at the electrode 502 or 503 (Zn²⁺+2e⁻->Zn). The electrolyte then may pass through a porous electrode, such as electrodes 505 and 504 in FIG. 5, where halogen ions of the electrolyte may oxidize forming molecular halogen reactant.

For the case illustrated in FIG. 5, chlorine ions of the metal-halide electrolyte oxidize at the electrodes 505 and 504 forming molecular chlorine. Because the system illustrated in FIG. 5 is placed under a pressure above the liquefication pressure for the halogen reactant, the halogen reactant, which is formed at the electrodes 505 and 504, is in liquid form. The electrolyte leaves the cell, such as cell 521 or 522, in a form of a mixture with the formed halogen reactant through the pipe or manifold 115. A concentration of the metal halide electrolyte in the mixture can be lower than a concentration of the electrolyte that entered the cell from the pipe 120. From the pipe 115, the mixture may enter the reservoir, where it can be separated into the halogen reactant and the metal electrolyte per se using, for example, gravity and an optional sump plate.

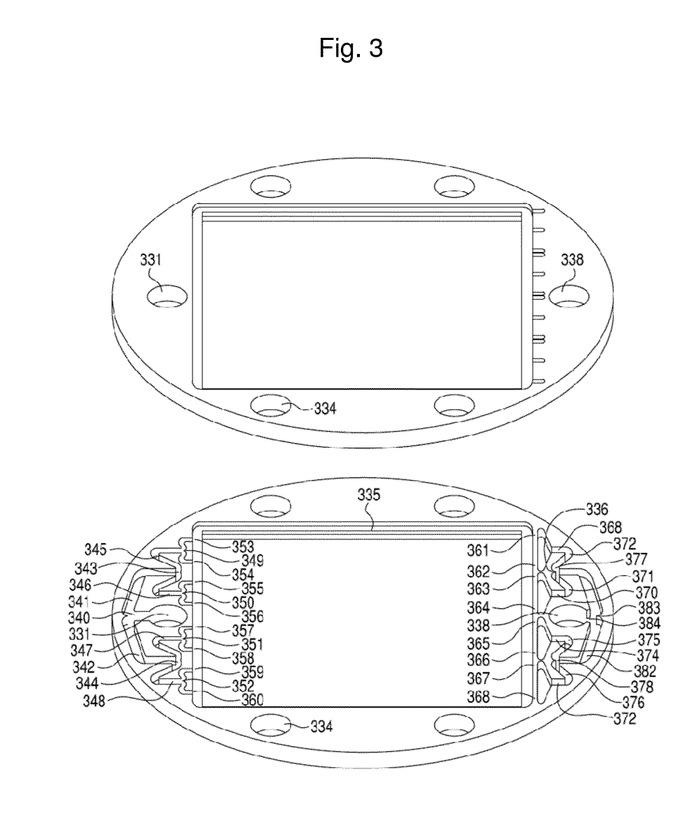

Before being delivered to the cells, the metal halide electrolyte mixed with the liquefied halogen reactant may undergo one or more flow splits, which may result in multiple flow paths to the porous electrode. These flow paths may have the same flow resistance. Each of the one or more splits may divide the flow into two. For example, FIG. 3 illustrates one possible cell design that has a first level splitting node 340, which splits the flow of the metal halide electrolyte and the liquefied halogen reactant, which is provided through the feed manifold 331, into subflows 341 and 342. Each of the subflows 341 and 342 may further split into two next level subflows at second level splitting nodes 343 and 344 respectively. Each of the four subflows 345, 346, 347, and 348, that are formed at the second level nodes, further split into two third level subflows at third level nodes 349, 350, 351 and 352 respectively.

As the result of the three levels of splitting, the flow of the metal halide electrolyte and the liquefied halogen reactant may enter the cell through eight separate paths 353, 354, 355, 356, 357, 358, 359, 360, each of which has the same flow resistance because they have the same length and the same number of turns, which have the same radius, i.e. the same geometry. The flow splitting nodes may split the flow of the electrolyte and the halogen reactant for each cell of the stack.

The electrolyte and the liquefied halogen reactant may leave the cell through a multiple flow paths or through a single flow path.

In some embodiments, the multiple flow paths may merge into a lesser number of flows before reaching the return manifold or pipe. For example, FIG. 3 shows that the electrolyte and the liquefied halogen reactant may leave the cell through eight flow paths 361-368. Adjacent flow paths 361 and 362, 363 and 364, 365 and 366, 367 and 368 merge at first-level merging nodes 369-372 into second-level flow paths 373, 374, 375 and 376 respectively. The second level flow paths further merge at four second level merging nodes 377 and 378 forming two third-level flow paths 381 and 382, which further merge at a third-level node 383, forming a single flow 384, which enters the return manifold 338. Each of the flow paths 361-368 have the same flow resistance as they have the same length and the same number of turns, which have the same radius, on its way to the return manifold.

FIG. 3 illustrates an electrochemical cell that comprises a cell frame. Such an electrochemical cell may be used to achieve the structures and flows shown in FIG. 2. The cell frame may include a feed manifold element 331, distribution channels, flow splitting nodes, spacer ledge 335, flow merging nodes, collection channels, return manifold element 338, and bypass conduit elements 334.

In some embodiments, plural cell frames, that are each identical or similar to the frame depicted in FIG. 3, may be stacked vertically with the electrodes in place, to form the stack shown in FIG. 2. To form such a stack, the feed manifold element, such as the element 331 in FIG. 3, in each of the plural cells frames may be aligned with the feed manifold element in another of the cell frames, thereby to form a feed manifold of the system. The distribution channels and the flow splitting nodes in each of the cell frames may be aligned with the distribution channels and the flow splitting nodes in another of the cell frames, thereby forming a distribution zone of the system. The positive electrode (discharge mode) of each of the cells sits above or below the negative electrode (discharge mode) for each cell on the spaces ledges of the cell frames, thereby forming alternating layers of positive electrodes and negative electrodes.

The flow merging nodes and the collection channels in each of the plural cells frames may be aligned with the flow merging nodes and the collection channels in another of the cell frames, thereby forming a collection zone of the system. The return manifold element, such as the element 338 in FIG. 3, in each of the cell frames may be aligned with the return manifold element in another of the cell frames, thereby forming a return manifold of the system. The bypass conduit element, such as the element 334 in FIG. 3, in each of the cell frames may be aligned with the bypass conduit element in another of the cell frames, thereby forming a bypass conduit of the system. The bypass conduit may be used for fluid flow and/or electrical wires or cables.

In some embodiments, the cell frame may have a circular shape. Such a shape may facilitate insertion of the plural cells into a pressure containment vessel, which has a cylindrical shape, thereby reducing a production cost for the system. The frames may comprise an electrically insulating material, which may be a polymer material, such as PVC.

The cell frame based design may facilitate a low-loss flow with uniform distribution for the electrolyte and the halogen reactant; a bipolar electrical design; an ease of manufacture, internal bypass paths, and elements by which the operational stasis mode (described below) may be achieved.

Advantages of the cell frame may include, but are not limited to, the flow-splitting design in the distribution zone that may include multiple order splits such as the first, second, and third order splits in the flow channels in FIG. 3, that result in multiple channels that each have the same flow resistance, because each of the channels has the same length and the number and radius of bends. FIG. 3 shows eight feed channels per cell that each have the same flow resistance. This design with multiple flow splits may allow maintenance of a laminar flow through each of the multiple channels. The design may allow equal division of flow volume between the multiple channels, independent of flow velocity, uniformity of viscosity, or uniformity of density in the electrolyte.

### Modes of Operation

An Off Mode may be used for storage or transportation of the electrochemical system. During the Off Mode, the metal halide electrolyte and the halogen reactant are not delivered to the cell. A small amount of the halogen reactant, which may remain in the horizontally positioned, may be reduced and combined with metal ions to form metal halide. For example, the remaining liquefied chlorine reactant may be reduced into halogen anions and combined with zinc ions to form zinc chloride.

In the off mode, the terminal electrodes of the one or more cells of the system may be connected via a shorting resistor, yielding a potential of zero volts for the cells of the system. In some embodiments, a blocking diode preferably may be used to prevent reverse current flow through the system via any external voltage sources.

During the Discharge Mode the discharge pump may be on and the mixture of the metal halide electrolyte and the halogen reactant may be circulated through the cell(s) of the system. Electrons may be released as metal cations are formed from the oxidizable metal that constitutes the negative electrode. The released electrons may be captured by the halogen reactant, thereby reducing the reactant to halogen anions and creating an electrical potential on terminal electrodes of the cell(s) of the system. The demand for power from the system may consume the halogen reactant, causing a release of an additional dose of the liquefied halogen reactant from the reservoir into the feed pipe or manifold of the system.

During the Stasis or Standby Mode, there may be little or no flow of the metal halide electrolyte and the halogen reactant. The availability of the system may be maintained via a balancing voltage. This balancing voltage may prevent a self-discharge of the system by maintaining a precise electrical potential on the cell(s) of the system to counteract the electrochemical reaction forces that can arise when there is no circulation of the metal halide electrolyte and the halogen reactant. The particular design of the cell plates disclosed may interrupt shunt currents that would otherwise flow through the feed and return manifolds, while maintaining cell-to-cell electrical continuity.

### Separation Device

FIG. 7 illustrates another embodiment of the reservoir 119 which has a separation device 703. The reservoir 119 of the embodiment of FIG. 7 may be used with the system and method of any of the embodiments described above. The baffle plates 604 of the embodiment of FIG. 6 are optional and are not shown in the bottom portion of the reservoir 119 for clarity. The separation device 703 can be, for example, a molecular sieve, a selective membrane, or other device that is capable of separating one component of the electrolyte mixture from other components of the electrolyte, thereby facilitating modes of operation (e.g., charge and discharge) of the flow battery. The separation device 703, having an appropriate geometry and properties for separating the desired components, is preferably disposed in the reservoir 119 between the inlet to the feed line 607 and the pump inlets/outlets 605 and 606 to separate the electrolyte mixture in reservoir 119 into two volumes 705, 707 during the flow battery operation.

The first volume 705 is provided for selective electrolyte component accumulation and the second volume 707 is provided for selective liquefied halogen (such as aqueous chlorine) accumulation. The second volume 707 can be located below the first volume, thereby taking advantage of the liquefied halogen having a higher density than the remaining electrolyte components. Thus, the halogen permeation from volume 705 into volume 707 may be assisted by gravity. However, depending on the type and operation of separation device 703 and the particular electrolyte and halogen components, volume 707 may be located above or to the side of volume 705.

An appropriate molecular sieve or membrane 703 can selectively allow desired molecules to pass there through. The selectivity can be based on, for example, a molecular size, and/or an electrical charge of a component.

The permeability of the molecular sieve or membrane can be variable as a function of parameters such as pressure, temperature, chemical concentration, etc. One example of a molecular sieve comprises a mesoporous carbon membrane that provides size-based selectivity of molecules that can diffuse therethrough. Larger molecules are more difficult to penetrate the pores. This provides a higher permeability to the liquefied halogen reactant (e.g., aqueous chlorine) than the metal-halide electrolyte component (e.g., zinc chloride). In addition, the separation device can further comprise a device configured to apply an electric field over the membrane or the molecular sieve. An externally applied electric field can facilitate molecular diffusion through the membrane and aid the electrical-charge-based selective diffusion.

Depending on the specific liquefied halogen and the metal halide electrolyte used, the molecular sieves can be selected to have pore sizes suitable for passing predetermined molecules. Some examples of molecular sieves are described, for example, in U.S. Pat. No. 3,939,118. The molecular sieves can include granular natural or synthetic silica-alumina materials which can have lattice structures of the zeolite type (see, e.g., the monograph Molekularsiebe (Molecular Sieves) by O. Grubner, P. Jiro and M. Ralek, VEB-Verlag der Wissenschaften, Berlin 1968), with pore widths of 2 \acute{Å} to 10 \acute{Å} (e.g., zeolite powder or bead sieves, such as Grace Davison SYLOSIV® brand powders), silica gel with pore widths of 40 \acute{Å} to 100 \acute{Å}, which are optionally absorbed in glass beads, and modified borosilicate glasses according to W. Haller (J. Chem. Phys. 42, 686 (1965)) with pore widths between 75 \acute{Å} and 2,400 \acute{Å}. Molecular sieves based on organic products may also be used. These products include 3-dimensionally crosslinked polysaccharides such as dextran gels (Sephadex grades, a product marketed by GE Healthcare Life Sciences), which can optionally be alkylated (Sephadex-LH grades, a product marketed by GE Healthcare Life Sciences), agarose gels (Sepharose, a product marketed by GE Healthcare Life Sciences), cellulose gels and agar gels. Other examples of synthetic organic gels include crosslinked polyacrylamides andpolyethylene oxides crosslinked via acrylate groups (trade name Merckogel OR). Ion exchange gels such as three-dimensionally crosslinked polystyrenes provided with sulphonic acid groups and the dextran gels already mentioned above, where they possess the acid groups or ammonium groups required for ionexchange (dextran gel ion exchangers), may also be used.

The separation device can include a porous container or a tray that holds the membrane or the molecular sieve materials. The molecular sieve materials could be in granular or powder form. The container can include electrodes or conductive plates for applying an electric field to the membrane or the molecular sieve materials. A voltage can be applied to the electrodes or conductive plates from a voltage output of the flow battery, or from a different power source (e.g., grid power, small battery located inside or outside the flow battery vessel 101, etc.). The voltage applied to the separation device facilitates the selective diffusion of the liquefied halogen reactant through the separation device. The separation device can be permanently coupled (e.g., welded, glued, etc.) or removably coupled (e.g., bolted, clamped, etc.) to a wall of the reservoir 119. Alternatively, only the granular molecular sieve materials or the membrane may be removable from the porous container or tray, while the container or tray may be permanently coupled to the wall of the reservoir.

It should be noted that the first volume 705 does not have to exclusively contain only the remaining electrolyte components and that the second volume 707 does not have to exclusively contain only the liquefied halogen (such as aqueous chlorine). A substantial concentration difference of halogen reactant or remaining electrolyte components across the separation device 703 is sufficient. Thus, the first volume 705 may contain the liquefied halogen in addition to the remaining electrolyte components and the second volume 707 may contain the remaining electrolyte components in addition to the liquefied halogen, as long as there is a higher liquefied halogen concentration in volume 707 than in volume 705, and/or as long as there is a higher remaining electrolyte components concentration in volume 705 than in volume 707. The concentration difference can be, for example, an at least 10% difference in concentration of the halogen reactant between the first and second volumes, such as an at least 50% difference, such as an at least 100% difference, such as an at least 200% difference, for example a 10-500% difference. The separation device 703 can be selected (e.g., a specific pore size may be selected) and/or operated (e.g., by applying a particular voltage) to provide the desired concentration difference.

In the discharge mode of flow battery operation illustrated in FIG. 7, the feed line 607 has an inlet in the second volume 707 of the reservoir 119 below the separation device 703, and feeds fluid with a higher concentration of halogen reactant (i.e., the fluid with a higher concentration of desired elements for discharge flow function) from volume 707 into the flow loop. The inlet 605 of the discharge pump intakes the fluid from the first volume 705, which has a higher concentration of the remaining electrolyte components than volume 707. Optionally, the inlet 605 of the discharge pump may be omitted or may remain inoperative during discharge mode if sufficient electrolyte is present in the second volume 707. The electrolyte and the liquid halogen are mixed in the flow loop and after flowing through the cells and undergoing reactions therein, the fluid mixture is discharged back into the reservoir 119. Preferably, the mixture is discharged into the first volume 705 from charge pump inlet/outlet 606. However, a different, separate outlet may be used to discharge the mixture into volume 705 from the flow loop. Unused halogen reactant selectively or preferentially permeates through the separation device 703 (i.e., halogen reactant permeates through device 703 at a higher rate than the remaining electrolyte components) and selectively or preferentially accumulates in the second volume 707. Other electrolyte components have a lower permeability through the separation device 703 than the halogen and preferentially remain in the first volume 705. A concentration difference described above is thus established and maintained with the help of the separation device 703.

In the charge mode illustrated in FIG. 8, the remaining electrolyte components in the first volume 705 are fed into the flow loop by the charge pump inlet 606 located in the first volume 705 above the separation device 703. The concentrated halogen in the second volume 707 is preferably excluded or minimized from being taken into the flow loop. After flowing through the cells and undergoing reactions therein, the fluid is discharged back into the reservoir 119. Preferably, the fluid is discharged from the discharge pump inlet/outlet 605 into the first volume 705. However, a different, separate outlet may be used to discharge the fluid into volume 705 from the flow loop. The discharged fluid is separated by the separation device 703, the halogen reactant selectively permeates into the second volume 707, leaving a higher concentration of the electrolyte component(s) in the first volume 705 than in the second volume 707.

Advantageously, the separation device enables an architecture with simplified single flow loop plumbing, valving, pump layout, etc. Alternative flow battery designs typically require two independent flow systems which are more complicated, more costly, and are more prone to cross leakage, etc.

### State of Charge Measurement

In some embodiments, a measurement subsystem including one or more sensors is employed in the electrochemical system to determine a state of charge (SOC) of the electrochemical system. The SOC is a measure of the amount of energy stored in a battery, typically as a percentage of the energy stored in a fully charged state of the battery. Initial calibration of the capacity of the battery is often performed before the SOC can be determined as the energy stored in a fully charged state of the battery can degenerate after some cycles of charging and recharging.

The measurement subsystem can be configured to determine the SOC based on many different methods, such as chemical, voltage, current, pressure, optical and/or impedance based measurements. In one embodiment, the subsystem and method includes all measurement methods except an optical measurement (i.e., an optical measurement is excluded). In another embodiment, the measurement method optionally excludes optical absorption spectroscopy measurement of the electrolyte. In yet another embodiment, the measurement method optionally includes optical absorption spectroscopy measurement of the electrolyte. The measurement can be direct, indirect or a combination thereof. For example, direct measurement includes monitoring the charging or discharging processes of the electrochemical system (e.g., by monitoring electrical properties and/or output of the system). Indirect measurement includes, for example, inferring the SOC from quantitative or qualitative measurement of non-electrical properties (e.g., pressure, chemical, thickness, optical, etc. properties described below) of the electrochemical system using sensors. If an indirect measurement is used, then the SOC can be determined from measured properties of the system by comparing these properties with a reference, such as for example, a table, a chart, or a model simulation.

The SOC may be determined by a person, such as a system operator, or by a machine, such as a computer or a dedicated logic device or circuit. For example, the SOC may be determined by a person viewing a display (e.g., on a computer monitor) or printout of the measured data generated by the sensor(s). The person can then determine the SOC by comparing the sensor data to a table, chart or other reference. A machine can determine the SOC by using software or hardware which compares the data generated by the sensor(s) to a reference, such as a table, chart or simulation. The machine can then output the SOC value to a display, a printer and/or store the value in memory.

A person (e.g., system operator) or machine (e.g., a general purpose computer running system control software or a dedicated control system) can then adjust the operating parameters of the system (e.g., voltage or current output) based on the SOC measurement. The control system which adjust the operating parameters may be the same or a different machine that determines the SOC.

The operator and/or the control system may be located in the same building as the system or in a remote location. For example, the SOC of the system used by a customer (e.g., a power generation utility) may be monitored by a person or machine located remotely from the system at the system manufacturer or monitoring service. In this configuration, the output of the sensors may be provided to the operator or control system wirelessly (e.g., via a wireless data transmitter electrically connected to the sensors) and/or via a wired connection (e.g., via the Internet).

The methods of this embodiment can be used to determine a quantitative (e.g., numerical) value of the SOC and/or a qualitative value of the SOC. For example, a qualitative value may be a determination of whether the SOC is increasing or decreasing with time or in response to a change in settings of the system, without measuring an actual numerical value of the SOC.

In general, the SOC is proportional to concentration of the metal halide (e.g., zinc chloride) in the electrolyte, the amount of halogen (e.g., chlorine) in the system and the amount of metal (e.g., zinc) deposited on its respective electrode. Any one, two or all three of these values may be measured to determine the SOC. For example, an amount of the liquefied halogen reactant in the system and the concentration of the metal halide in the electrolyte and can be measured for example, by directly sampling the fluid from the fluid circuit with a chemical sensor or a hydrometer, or indirectly through the measurement of a color, a pH value, or a volume of the fluid, as will be described in more detail below.

The following properties of the metal halide concentration in electrolyte can be used to determine the SOC.

Electrical conductivity of the electrolyte can be an used as an indication of the SOC, and can be measured using, for example, a conductivity sensor disposed in the fluid.

Viscosity of the electrolyte can be measured at one or more locations, using, for example, a viscometer, and can be used as an indication of the SOC because the viscosity may decrease with an increasing SOC. Other fluid properties that can be measured to determine the SOC include, for example, a measurement of the density of the electrolyte. The density can be measured using a density meter or a specific gravity meter located in the fluid. The density of the electrolyte may decrease with a higher SOC. Thus, a decreasing or low viscosity or density of the electrolyte indicates an increasing or high SOC. A table listing or a chart showing a calibrated SOC versus the viscosity, density or specific gravity can be provided to an operator or control system for determining the SOC based on the measurements.

The refractive index of the electrolyte may decrease with a higher SOC. Accordingly, a refractometer can be deployed to measure the refractive index of the electrolyte as an indication of the SOC. The refractormer may be located in any location in the system where it is capable of measuring the refractive index of the electrolyte. Thus, a decreasing or low refractive index of the electrolyte indicates an increasing or high SOC. A table listing or a chart showing a calibrated SOC versus the refractive index can be provided to an operator or control system for determining the SOC based on the measurements.

The halogen (e.g., chlorine) amount in the system can also be used to determine the SOC.

The color of the electrolyte may become more yellow when the SOC is higher. The electrolyte color can be measured using a color or chromatic sensor, such as a camera, positioned anywhere in the system where it can determine the color of the electrolyte.

Thus, an increasing or high yellowness of the electrolyte indicates an increasing or high SOC. A table listing or a chart showing a calibrated SOC versus the electrolyte color can be provided to an operator or control system for determining the SOC based on the measurements.

The system pressure may increase when the SOC is higher, and can be measured using a pressure sensor. The pressure sensor can be disposed, for example, in the electrolyte, or in the reservoir 119 above the fluid line 608 shown in FIG. 6.

The liquid volume may increase with a higher SOC, and can be measured using a fluid level sensor, a float, or from a sampling window. A float is a floating sensor which floats on top of the fluid in reservoir 119 and provides information about position of the fluid line 608 in reservoir 119. For systems containing a window, the sampling window may contain lines or measurement markings which allow the position of the fluid line 608 to be observed by the operator or measured by an optical sensor or camera. Thus, an increasing or high pressure or liquid volume indicates an increasing or high SOC. A table listing or a chart showing a calibrated SOC versus the pressure or volume can be provided to an operator or control system for determining the SOC based on the measurements.

The pH value of the electrolyte may decrease with a higher SOC, and can be measured using a pH sensor disposed in the fluid. The oxidation reduction potential (ORP) of the electrolyte may increase with a higher SOC, and can be measured using an electrode disposed in the fluid and a reference electrode. Off-the-shelf sensors can be used, such as the Model 1056 Analyzer and the Model 3500 pH/ORP sensor from Emerson Process Management. Thus, an increasing or high ORP and/or a decreasing or low pH indicates an increasing or high SOC. A table listing or a chart showing a calibrated SOC versus the pressure or volume can be provided to an operator or control system for determining the SOC based on the measurements.

The following properties of metal deposition can also be used to determine the SOC.

The thickness of the metal electrodes in the stack, such as the thickness of the zinc electrodes, may increase with a higher SOC. The thickness of the deposited zinc can be measured using an optical device, such as a camera, a mechanical device, and/or an ultrasound device.

A differential pressure in the stack of cells may increase with a higher SOC, and can be measured with a plurality of pressure sensors disposed downstream and upstream from the stack in the fluid loop.

If desired, the electrical properties of the stack may also be used to measure the SOC. For example, a resistance of the stack of cells may decrease with a higher SOC. The resistance can be measured using a resistivity meter which is electrically connected to the stack. Alternatively, an impedance of the stack of cells may decrease with a higher SOC. The impedance can be measured using a vector network analyzer or impedance spectroscopy system.

Coulomb counting techniques can be employed to directly measure the discharge current or charge current integrated over a time period. The electrical current can be measured using a sense resistor, a Hall effect transducer, or a giant magnetoresistive sensor. Because the absolute capacity of the battery can drift with time, the SOC should be re-calibrated regularly, and the Coulomb counting should be compensated for the environmental variations, such as temperature. Compensated Coulomb counting can also use one or more other measurements, such as those described above, for the calibration such that the counting is compensated by the above described measurements and mechanisms.

Any one or more sensors and methods described above can be deployed at the same time to provide a real time measurement of the SOC. In particular, when two or more different types of sensors described above are used in any possible combination to measure the properties of the system using different methods, a more accurate determination of the SOC may be provided.

As illustrated in FIG. 6, a sensor 610, 612, such as a conductivity sensor, can be disposed in the upper portion 125 of the reservoir, and/or at the lower portion 126 of the reservoir. A plurality of such sensors 610, 612 can be disposed in various locations in the reservoir or inside the fluid lines in, upstream and/or downstream of the stack to measure the properties of the fluid at different locations. The difference and gradient of the fluid properties in the different locations can better characterize the SOC than measurements performed at a single location. Another sensor 614 comprising, for example, a float or a gas pressure sensor can be disposed in a portion of the reservoir that is on or above the upper level 608 of the metal-halide electrolyte. Thus, sensor(s) 610, 612 may be used to measure fluid properties while sensor 614 may be used to measure non-fluid properties (e.g., pressure). Other locations where one or more sensors can be disposed include the inner volume 102 of the sealed container 101 (FIG. 1), various higher pressure second zones 129, 130 and 131 of the inner volume of the vessel 101, an upward return manifold 27 (FIG. 2) or 121 (FIG. 1), a return pipe 29 (FIG. 2) or 122 (FIG. 1), a feed pipe or manifold 21 (FIG. 2) or 115 (FIG. 1), a pump 123 or 124, a pipe or conduit 132, a feed line 127, or inside one or more of the cells 103 (e.g., zinc thickness or resistance measurement sensors).

Similar to the sensors illustrated in FIG. 6, various sensors can be disposed in the system illustrated in FIGS. 7 and 8, where in particular the differences in concentration or other fluid properties across the separation device 703 can be measured by a plurality of sensors 710, 712 disposed on both sides of the separation device 703. The sensors 710, 712 can be the same type of sensors. The measured fluid property differentials indicate both the effectiveness of the separation device 703 and the SOC of the battery. Thus, the difference in the output of sensors 710 and 712 can be used to determine the effectiveness of the device 703. If desired, a first set of sensors 710, 712 may be positioned near the halogen feed line inlet 607 (e.g., on the side of the reservoir 119 containing the inlet 607) for discharge mode measurements, as shown in FIG. 7. A second set of sensors 710, 712 may be positioned near the charge pump inlet/outlet 606 (e.g., on the side of the reservoir 119 containing the inlet/outlet 606) for charge mode measurements, as shown in FIG. 8.

Advantageously, the measurement subsystem enables the electrochemical system to be monitored for its SOC in real time, allowing the user to adjust the operation of the electrochemical system based on the SOC. More efficient electrochemical systems can thus be designed with longer lifetime.

Although the foregoing refers to particular preferred embodiments, it will be understood that the invention is not so limited. It will occur to those of ordinary skill in the art that various modifications may be made to the disclosed embodiments and that such modifications are intended to be within the scope of the invention. All of the publications, patent applications and patents cited herein are incorporated herein by reference in their entirety.

What is claimed is:

1. An electrochemical system comprising a vessel, wherein the vessel contains:
(a) at least one cell that comprises:
a first electrode;
a second electrode; and
a reaction zone between the first and second electrodes;
(b) a flow circuit configured to deliver a fluid comprising a liquefied halogen reactant and at least one metal halide electrolyte to the at least one cell; and
(c) at least one sensor configured to measure a property of the electrochemical system indicative of a state of charge (SOC) of the electrochemical system.

2. The system of claim 1, wherein the at least one sensor is configured to directly measure the property.

3. The system of claim 1, wherein the at least one sensor is configured to indirectly measure the property.

4. The system of claim 3, wherein the at least one sensor is configured to indirectly measure the property associated with at least one of a concentration of the metal halide in the electrolyte, an amount of the halogen reactant in the system, and an amount of the metal deposited on the first or the second electrode, which is indicative of the state of charge (SOC) of the electrochemical system.

5. The system of claim 1, wherein the at least one sensor is configured to measure the property of the electrochemical system indicative of at least one of a quantitative or qualitative state of charge (SOC) of the electrochemical system.

6. The system of claim 1, wherein the at least one sensor is configured to measure at least one of:
a concentration of the at least one metal halide in the electrolyte;
an electrical conductivity of the fluid;
a viscosity of the fluid;
a density of the fluid;
a refractive index of the fluid;
an amount of the liquefied halogen reactant;
a color of the fluid;
a system pressure;
a pH value of the fluid;
an oxidation reduction potential of the fluid;
a volume of the fluid;
a thickness of one of the first or second electrodes;
a differential pressure in the at least one cell;
a resistance or impedance of the at least one cell; or
a compensated Coulomb count.

7. The system of claim 6, wherein the at least one sensor comprises at least one of:
a conductivity sensor configured to measure the conductivity of the fluid;
a viscometer configured to measure the viscosity of the fluid;
a density meter or a specific gravity meter configured to measure the density of the fluid;
a refractometer configured to measure the refractive index of the fluid;
a color or chromatic sensor configured to measure the color of the fluid;
a pressure sensor configured to measure the pressure of the system;
a pH sensor configured to measure the pH value of the fluid;
an electrode configured to measure the oxidation reduction potential of the fluid;
a fluid level sensor, a float, or a sampling window configured to measure the volume of the fluid;
an optical, a mechanical or an ultrasound device configured to measure the thickness of one of the first or second electrodes;
a resistivity meter configured to measure the resistance of the at least one cell;
a vector network analyzer or an impedance spectroscopy system configured to measure the impedance of the at least one cell; or
a sense resistor, a Hall effect transducer, or a giant magnetoresistive sensor configured for the compensated Coulomb counting.

8. The system of claim 7, wherein the measurement subsystem comprises at least two different types of sensors configured to determine the SOC using at least two different methods.

9. The system of claim 1, further comprising:
(d) a reservoir containing a first volume configured to selectively accumulate the metal halide electrolyte and a second volume configured to selectively accumulate the liquefied halogen reactant; and
(e) a separation device separating the first volume from the second volume, the separation device having a higher permeability to the liquefied halogen reactant than the metal halide electrolyte.

10. The system of claim 9, wherein the at least one sensor comprises a first sensor disposed in the first volume and a second sensor disposed in the second volume, and wherein the first and second sensors are configured to measure a difference in a property of the electrolyte between the first and the second volumes.

11. The system of claim 1, wherein the at least one sensor comprises a first sensor disposed in the flow circuit upstream of the at least one cell and a second sensor disposed downstream of the at least one cell, and wherein the first and second sensors are configured to measure a property differential of the at least one electrolyte between upstream and downstream of the at least one cell.

12. The system of claim 1, wherein the vessel comprises a sealed vessel, the liquefied halogen reactant comprises liquefied chlorine, at least one metal halide electrolyte comprises a zinc chloride electrolyte, and the at least one cell comprises a hybrid flow battery cell which lacks an ion exchange membrane in the reaction zone between the first and the second electrode.

13. A method of determining a state of charge (SOC) of an electrochemical system, wherein the electrochemical system comprises a vessel which contains at least one cell that comprises a first electrode, a second electrode, and a reaction zone between the first and second electrodes;
wherein the method comprises:
measuring a property of the electrochemical system as a flow of a fluid comprising a metal halide electrolyte and a halogen reactant are conveyed through the reaction zone of the at least one cell; and
determining the SOC of the electrochemical system based on the measured property.

14. The method of claim 13, wherein the step of measuring comprises directly measuring the property.

15. The method of claim 13, wherein the step of measuring comprises indirectly measuring the property.

16. The method of claim 15, wherein the step of measuring comprises indirectly measuring the property associated with at least one of a concentration of the metal halide in the electrolyte, an amount of the halogen reactant in the system, and an amount of the metal deposited on the first or the second electrode, which is indicative of the state of charge (SOC) of the electrochemical system.

17. The method of claim 13, wherein the step of measuring comprises measuring the property of the electrochemical system indicative of at least one of a quantitative or qualitative state of charge (SOC) of the electrochemical system.

18. The method of claim 13, wherein said measuring comprises measuring at least one of:
a concentration of the at least one metal halide in the electrolyte;
an electrical conductivity of the fluid;
a viscosity of the fluid;
a density of the fluid;
a refractive index of the fluid;
an amount of the liquefied halogen reactant;
a color of the fluid;
a system pressure;
a pH value of the fluid;
an oxidation reduction potential of the fluid;
a volume of the fluid;
a thickness of one of the first or second electrodes;
a differential pressure in the at least one cell;
a resistance or impedance of the at least one cell; or
a compensated Coulomb count.

19. The method of claim 13, wherein:
the at least one cell comprises a hybrid flow battery cell which lacks an ion exchange membrane in the reaction zone between the first and the second electrode;
the vessel further comprises a reservoir containing a first volume and a second volume separated by a separation device;
the metal halide electrolyte from the first volume and the liquefied halogen reactant from the second volume are mixed to form an electrolyte mixture;
the electrolyte mixture is provided to the at least one cell in a discharge mode to generate electricity;
the electrolyte mixture is returned from the at least one cell to the first volume in the reservoir, such that unused liquefied halogen reactant from the returned electrolyte mixture selectively permeates from the first volume through the separation device to the second volume; and
said measuring comprises measuring a concentration of the metal halide electrolyte in both the first and the second volumes.

20. The method of claim 13, wherein the step of measuring comprises measuring at least two properties of the electrochemical system using two different methods.
